(19) United States
(12) Patent Application Publication
(10) Pub. No.: US 2005/0070658 A1
(43) Pub. Date: Mar. 31, 2005

(54) Electrically conductive compositions, methods of manufacture thereof and articles derived from such compositions

(76) Inventors: Soumyadeb Ghosh, Bangalore (IN); Sumanda Bandyopadhyay, Bangalore (IN)

Correspondence Address: CANTOR COLBURN, LLP, 55 GRIFFIN ROAD SOUTH, BLOOMFIELD, CT, 06002, US

(21) Appl. No.: 10/675,108

(22) Filed: Sep. 30, 2003

(51) Int. Cl. C08K 3/04

(52) U.S. Cl. 524/495

(57) ABSTRACT

Disclosed herein is a conductive composition comprising an organic polymer; graphite; and a nanosized conductive filler and/or carbon fibers having a diameter of greater than or equal to about 1000 nanometers. Disclosed herein too is a method for manufacturing a composition comprising blending an organic polymer; graphite; and a nanosized conductive filler, wherein the composition has an electrical volume resistivity less than or equal to about 10e⁸ ohm-cm.

### BACKGROUND

This disclosure relates to electrically conductive compositions, methods of manufacture and articles derived from such compositions.

Organic polymers are generally used in applications where light weight, ductility and impact strength are desired. However, organic polymers are electrically insulating in nature and are therefore not used in applications where resistive heating is utilized. It is therefore desirable to have a conductive composition comprising organic polymers that can be resistively heated.

### BRIEF DESCRIPTION OF THE INVENTION

Disclosed herein is an injection moldable conductive composition comprising an organic polymer; a nanosized conductive filler and/or carbon fibers having a diameter of greater than or equal to about 1,000 nanometers; and graphite.

Disclosed herein too is a method for manufacturing a composition comprising blending an organic polymer; a nanosized conductive filler and/or carbon fibers having a diameter of greater than or equal to about 1,000 nanometers, and graphite; and wherein the composition has an electrical volume resistivity less than or equal to about 10e⁸ ohm-cm.

### BRIEF DESCRIPTION OF THE DRAWINGS

FIG. 1 depicts a bar plot showing the electrical conductivity for conductive compositions that have only graphite versus those compositions that contains both graphite and nanosized conductive fillers; and

FIG. 2 depicts a bar plot comparing the conductivity for different organic polymers containing different levels of the nanosized conductive fillers and graphite. The filler loading along the x-axis indicates the total filler loading and the organic polymer into which the filler was loaded, while the numbers in the bars indicate the weight percent of the nanosized conductive fillers.

### DETAILED DESCRIPTION OF PREFERRED EMBODIMENTS

Disclosed herein are electrically conductive injection moldable compositions comprising an organic polymer, a nanosized conductive filler and/or carbon fibers having a diameter greater than 1000 nanometers, and graphite. The electrically conductive compositions can be advantageously resistively heated without undergoing substantial changes in shape. The ratio of either the nanosized conductive fillers and/or the carbon fibers to graphite is about 1:6 to about 1:80. The electrically conductive compositions are advantageously injection moldable and have melt viscosities of about 100 to about 600 Pascal-seconds (Pa-s) at 1500 sec¹.

In one embodiment, the conductive composition has a bulk volume electrical volume resistivity of less than or equal to about 10e⁸ ohm-cm and a surface resistivity greater than or equal to about 10⁸ ohm/square. In another embodiment, the conductive composition has a surface resistivity less than or equal to about 10⁸ ohm/square and a bulk volume resistivity less than or equal to about 10⁸ ohm-cm. In yet another embodiment, the conductive composition has a surface resistivity of less than or equal to about 10⁸ ohm/square (ohm/sq) and a bulk volume resistivity greater than or equal to about 10⁸ ohm-cm.

The organic polymer used in the conductive compositions may be selected from a wide variety of thermoplastic resins, thermosetting resins, blend of thermoplastic resins, or blends of thermoplastic resins with thermosetting resins. The organic polymer may also be a blend of polymers, copolymers, terpolymers, or combinations comprising at least one of the foregoing organic polymers. Examples of the organic polymer are polyacetals, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, or the like, or a combination comprising at least one of the foregoing organic polymers.

Examples of blends are acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, nylon/elastomers, polyester/elastomers, polyethylene terephthalate/polybutylene terephthalate, acetal/elastomer, styrene-maleicanhydride/acrylonitrile-butadiene-styrene, polyether etherketone/polyethersulfone, polyether etherketone/polyetherimide polyethylene/nylon, polyethylene/polyacetal, and the like.

Examples of thermosetting resins include polyurethane, natural rubber, synthetic rubber, epoxy, phenolic, polyesters, polyamides, silicones, and mixtures comprising any one of the foregoing thermosetting resins. Blends of thermoset resins as well as blends of thermoplastic resins with thermosets can be utilized.

In one embodiment, in order to derive the conductive composition, the organic polymer is polymerized from an organic polymer precursor while the nanosized conductive filler and the graphite are dispersed in the organic polymer precursor. The organic polymer precursor may be a monomer, dimer, trimer, or an oligomeric reactive species having up to about 20 repeat units, and which upon polymerization, yields an organic polymer having a number average molecular weight of greater than or equal to about 3,000 grams/mole (g/mole), preferably greater than or equal to about 5,000 g/mole, and more preferably greater than or equal to about 10,000 g/mole. The following section details examples of various organic polymers as well as the polymer precursors from which these organic polymers are polymerized. The polymer precursors detailed below are examples of monomers that may be polymerized in the presence of the graphite and the nanosized conductive fillers to obtain the conductive precursor composition.

In one embodiment, an organic polymer that may be used in the conductive composition is a polyarylene ether. The term poly(arylene ether) polymer includes polyphenylene ether (PPE) and poly(arylene ether) copolymers; graft copolymers; poly(arylene ether) ionomers; and block copolymers of alkenyl aromatic compounds with poly(arylene ether)s, vinyl aromatic compounds, and poly(arylene ether), and the like; and combinations comprising at least one of the foregoing. Poly(arylene ether) polymers per se, are polymers comprising a plurality of polymer precursors having structural units of the formula (I): 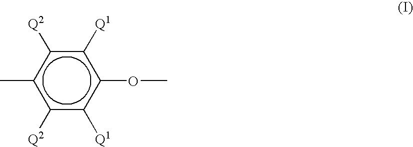
wherein for each structural unit, each Q¹ is independently hydrogen, halogen, primary or secondary lower alkyl (e.g., alkyl containing up to 7 carbon atoms), phenyl, haloalkyl, aminoalkyl, hydrocarbonoxy, halohydrocarbonoxy wherein at least two carbon atoms separate the halogen and oxygen atoms, or the like; and each Q² is independently hydrogen, halogen, primary or secondary lower alkyl, phenyl, haloalkyl, hydrocarbonoxy, halohydrocarbonoxy wherein at least two carbon atoms separate the halogen and oxygen atoms, or the like. Preferably, each Q¹ is alkyl or phenyl, especially C₁₋₄ alkyl, and each Q² is hydrogen.

Both homopolymer and copolymer poly(arylene ether)s are included. The preferred homopolymers are those containing 2,6-dimethylphenylene ether units. Suitable copolymers include random copolymers containing, for example, such units in combination with 2,3,6-trimethyl-1,4-phenylene ether units or copolymers derived from copolymerization of 2,6-dimethylphenol with 2,3,6-trimethylphenol. Also included are poly(arylene ether) containing moieties prepared by grafting vinyl monomers or polymers such as polystyrenes, as well as coupled poly(arylene ether) in which coupling agents such as low molecular weight polycarbonates, quinones, heterocycles and formals undergo reaction with the hydroxy groups of two poly(arylene ether) chains to produce a higher molecular weight polymer. Poly(arylene ether)s further include combinations comprising at least one of the above.

The poly(arylene ether) has a number average molecular weight of about 3,000 to about 30,000 g/mole and a weight average molecular weight of about 30,000 to about 60,000 g/mole, as determined by gel permeation chromatography. The poly(arylene ether) may have an intrinsic viscosity of about 0.10 to about 0.60 deciliters per gram (dl/g), as measured in chloroform at 25° C. It is also possible to utilize a high intrinsic viscosity poly(arylene ether) and a low intrinsic viscosity poly(arylene ether) in combination. Determining an exact ratio, when two intrinsic viscosities are used, will depend somewhat on the exact intrinsic viscosities of the poly(arylene ether) used and the ultimate physical properties that are desired.

The poly(arylene ether) is typically prepared by the oxidative coupling of at least one monohydroxyaromatic compound such as 2,6-xylenol or 2,3,6-trimethylphenol. Catalyst systems are generally employed for such coupling; they typically contain at least one heavy metal compound such as a copper, manganese or cobalt compound, usually in combination with various other materials.

Particularly useful poly(arylene ether)s for many purposes are those, which comprise molecules having at least one aminoalkyl-containing end group. The aminoalkyl radical is typically located in an ortho position to the hydroxy group. Products containing such end groups may be obtained by incorporating an appropriate primary or secondary monoamine such as di-n-butylamine or dimethylamine as one of the constituents of the oxidative coupling reaction mixture. Also frequently present are 4-hydroxybiphenyl end groups, typically obtained from reaction mixtures in which a by-product diphenoquinone is present, especially in a copper-halide-secondary or tertiary amine system. A substantial proportion of the polymer molecules, typically constituting as much as about 90% by weight of the polymer, may contain at least one of the aminoalkyl-containing and 4-hydroxybiphenyl end groups.

In another embodiment, the organic polymer used in the conductive composition may be a polycarbonate. Polycarbonates comprising aromatic carbonate chain units include compositions having structural units of the formula (II): 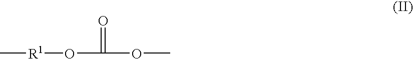
in which the R¹ groups are aromatic, aliphatic or alicyclic radicals. Preferably, R¹ is an aromatic organic radical and, more preferably, a radical of the formula (III):
-A¹⁻Y¹-A²- (III)
wherein each of A¹ and A² is a monocyclic divalent aryl radical and Y¹ is a bridging radical having zero, one, or two atoms which separate A¹ from A². In an exemplary embodiment, one atom separates A¹ from A². Illustrative examples of radicals of this type are —O—, —S—, —S(O)—, —S(O₂)—, —C(O)—, methylene, cyclohexyl-methylene, 2-[2,2, 1]-bicycloheptylidene, ethylidene, isopropylidene, neopentylidene, cyclohexylidene, cyclopentadecylidene, cyclododecylidene, adamantylidene, or the like. In another embodiment, zero atoms separate A¹ from A², with an illustrative example being bisphenol. The bridging radical Y¹ can be a hydrocarbon group or a saturated hydrocarbon group such as methylene, cyclohexylidene or isopropylidene.

Polycarbonates may be produced by the Schotten-Bauman interfacial reaction of the carbonate precursor with dihydroxy compounds. Typically, an aqueous base such as sodium hydroxide, potassium hydroxide, calcium hydroxide, or the like, is mixed with an organic, water immiscible solvent such as benzene, toluene, carbon disulfide, or dichloromethane, which contains the dihydroxy compound. A phase transfer agent is generally used to facilitate the reaction. Molecular weight regulators may be added either singly or in admixture to the reactant mixture. Branching agents, described forthwith may also be added singly or in admixture.

Polycarbonates can be produced by the interfacial reaction polymer precursors such as dihydroxy compounds in which only one atom separates A¹ and A². As used herein, the term “dihydroxy compound” includes, for example, bisphenol compounds having general formula (IV) as follows: 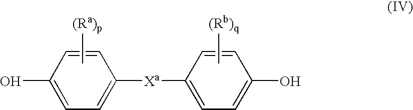
wherein R^{a} and R^{b} each independently represent hydrogen, a halogen atom, or a monovalent hydrocarbon group; p and q are each independently integers from 0 to 4; and X^{a} represents one of the groups of formula (V): 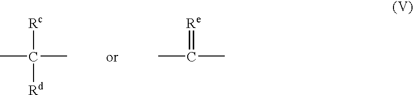
wherein R^{c} and R^{d} each independently represent a hydrogen atom or a monovalent linear or cyclic hydrocarbon group, and R^{e} is a divalent hydrocarbon group.

Examples of the types of bisphenol compounds that may be represented by formula (IV) include the bis(hydroxyaryl)alkane series such as, 1,1-bis(4-hydroxyphenyl)methane, 1,1-bis(4-hydroxyphenyl)ethane, 2,2-bis(4-hydroxyphenyl)propane (or bisphenol-A), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, bis(4-hydroxyphenyl)phenylmethane, 2,2-bis(4-hydroxy-1-methylphenyl)propane, 1,1-bis(4-hydroxy-t-butylphenyl)propane, 2,2-bis(4-hydroxy-3-bromophenyl)propane, or the like; bis(hydroxyaryl)cycloalkane series such as, 1,1-bis(4-hydroxyphenyl)cyclopentane, 1,1-bis(4-hydroxyphenyl)cyclohexane, or the like, or combinations comprising at least one of the foregoing bisphenol compounds.

Other bisphenol compounds that may be represented by formula (IV) include those where X is —O—, —S—, —SO— or —SO₂—. Some examples of such bisphenol compounds are bis(hydroxyaryl)ethers such as 4,4′-dihydroxy diphenylether, 4,4′-dihydroxy-3,3′-dimethylphenyl ether, or the like; bis(hydroxy diaryl)sulfides, such as 4,4′-dihydroxy diphenyl sulfide, 4,4′-dihydroxy-3,3′-dimethyl diphenyl sulfide, or the like; bis(hydroxy diaryl)sulfoxides, such as, 4,4′-dihydroxy diphenyl sulfoxides, 4,4′-dihydroxy-3,3′-dimethyl diphenyl sulfoxides, or the like; bis(hydroxy diaryl)sulfones, such as 4,4′-dihydroxy diphenyl sulfone, 4,4′-dihydroxy-3,3′-dimethyl diphenyl sulfone, or the like; or combinations comprising at least one of the foregoing bisphenol compounds.

Other bisphenol compounds that may be utilized in the polycondensation of polycarbonate are represented by the formula (VI) 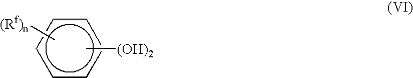
wherein, R^{f}, is a halogen atom of a hydrocarbon group having 1 to 10 carbon atoms or a halogen substituted hydrocarbon group; n is a value from 0 to 4. When n is at least 2, R^{f} may be the same or different. Examples of bisphenol compounds that may be represented by the formula (V), are resorcinol, substituted resorcinol compounds such as 3-methyl resorcin, 3-ethyl resorcin, 3-propyl resorcin, 3-butyl resorcin, 3-t-butyl resorcin, 3-phenyl resorcin, 3-cumyl resorcin, 2,3,4,6-tetrafloro resorcin, 2,3,4,6-tetrabromo resorcin, or the like; catechol, hydroquinone, substituted hydroquinones, such as 3-methyl hydroquinone, 3-ethyl hydroquinone, 3-propyl hydroquinone, 3-butyl hydroquinone, 3-t-butyl hydroquinone, 3-phenyl hydroquinone, 3-cumyl hydroquinone, 2,3,5,6-tetramethyl hydroquinone, 2,3,5,6-tetra-t-butyl hydroquinone, 2,3,5,6-tetrafloro hydroquinone, 2,3,5,6-tetrabromo hydroquinone, or the like; or combinations comprising at least one of the foregoing bisphenol compounds.

Bisphenol compounds such as 2,2,2′,2′-tetrahydro-3,3,3′,3′-tetramethyl-1,1′-spirobi-[IH-indene]-6,6′-diol represented by the following formula (VII) may also be used.

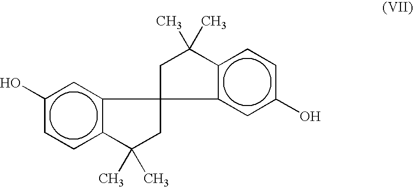

The preferred bisphenol compound is bisphenol A.

Typical carbonate precursors include the carbonyl halides, for example carbonyl chloride (phosgene), and carbonyl bromide; the bis-haloformates, for example, the bis-haloformates of dihydric phenols such as bisphenol A, hydroquinone, or the like, and the bis-haloformates of glycols such as ethylene glycol and neopentyl glycol; and the diaryl carbonates, such as diphenyl carbonate, di(tolyl) carbonate, and di(naphthyl) carbonate. The preferred carbonate precursor for the interfacial reaction is carbonyl chloride.

It is also possible to employ polycarbonates resulting from the polymerization of two or more different dihydric phenols or a copolymer of a dihydric phenol with a glycol or with a hydroxy- or acid-terminated polyester or with a dibasic acid or with a hydroxy acid or with an aliphatic diacid in the event a carbonate copolymer rather than a homopolymer is desired for use. Generally, useful aliphatic diacids have about 2 to about 40 carbons. A preferred aliphatic diacid is dodecanedioic acid.

Branched polycarbonates, as well as blends of linear polycarbonate and a branched polycarbonate may also be used in the composition. The branched polycarbonates may be prepared by adding a branching agent during polymerization. These branching agents may comprise polyfunctional organic compounds containing at least three functional groups, which may be hydroxyl, carboxyl, carboxylic anhydride, haloformyl, and combinations comprising at least one of the foregoing branching agents. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) α,α-dimethyl benzyl)phenol), 4-chloroformyl phthalic anhydride, trimesic acid, benzophenone tetracarboxylic acid, or the like, or combinations comprising at least one of the foregoing branching agents. The branching agents may be added at a level of about 0.05 to about 2.0 weight percent (wt %), based upon the total weight of the polycarbonate in a given layer.

In one embodiment, the polycarbonate may be produced by a melt polycondensation reaction between a dihydroxy compound and a carbonic acid diester. Examples of the carbonic acid diesters that may be utilized to produce the polycarbonates are diphenyl carbonate, bis(2,4-dichlorophenyl)carbonate, bis(2,4,6-trichlorophenyl) carbonate, bis(2-cyanophenyl) carbonate, bis(o-nitrophenyl) carbonate, ditolyl carbonate, m-cresyl carbonate, dinaphthyl carbonate, bis(diphenyl) carbonate, bis (methylsalicyl)carbonate, diethyl carbonate, dimethyl carbonate, dibutyl carbonate, dicyclohexyl carbonate, or the like, or combinations comprising at least one of the foregoing carbonic acid diesters. The preferred carbonic acid diester is diphenyl carbonate or bis (methylsalicyl)carbonate.

Preferably, the number average molecular weight of the polycarbonate is about 3,000 to about 1,000,000 grams/mole (g/mole). Within this range, it is desirable to have a number average molecular weight of greater than or equal to about 10,000, preferably greater than or equal to about 20,000, and more preferably greater than or equal to about 25,000 g/mole. Also desirable is a number average molecular weight of less than or equal to about 100,000, preferably less than or equal to about 75,000, more preferably less than or equal to about 50,000, and most preferably less than or equal to about 35,000 g/mole.

Cycloaliphatic polyesters may also be used in the conductive composition and are generally prepared by reaction of organic polymer precursors such as a diol with a dibasic acid or derivative. The diols useful in the preparation of the cycloaliphatic polyester polymers are straight chain, branched, or cycloaliphatic, preferably straight chain or branched alkane diols, and may contain from 2 to 12 carbon atoms.

Suitable examples of diols include ethylene glycol, propylene glycol, i.e., 1,2- and 1,3-propylene glycol; butane diol, i.e., 1,3- and 1,4-butane diol; diethylene glycol, 2,2-dimethyl-1,3-propane diol, 2-ethyl, 2-methyl, 1,3-propane diol, 1,3- and 1,5-pentane diol, dipropylene glycol, 2-methyl-1,5-pentane diol, 1,6-hexane diol, 1,4-cyclohexane dimethanol and particularly its cis- and trans-isomers, triethylene glycol, 1,10-decane diol, and mixtures of any of the foregoing. Particularly preferred is dimethanol bicyclo octane, dimethanol decalin, a cycloaliphatic diol or chemical equivalents thereof and particularly 1,4-cyclohexane dimethanol or its chemical equivalents. If 1,4-cyclohexane dimethanol is to be used as the diol component, it is generally preferred to use a mixture of cis- to trans-isomers in mole ratios of about 1:4 to about 4:1. Within this range, it is generally desired to use a mole ratio of cis- to trans-isomers of about 1:3.

The diacids useful in the preparation of the cycloaliphatic polyester polymers are aliphatic diacids that include carboxylic acids having two carboxyl groups each of which are attached to a saturated carbon in a saturated ring. Suitable examples of cycloaliphatic acids include decahydro naphthalene dicarboxylic acid, norbornene dicarboxylic acids, bicyclo octane dicarboxylic acids. Preferred cycloaliphatic diacids are 1,4-cyclohexanedicarboxylic acid and trans-1,4-cyclohexanedicarboxylic acids. Linear aliphatic diacids are also useful when the polyester has at least one monomer containing a cycloaliphatic ring. Illustrative examples of linear aliphatic diacids are succinic acid, adipic acid, dimethyl succinic acid, and azelaic acid. Mixtures of diacid and diols may also be used to make the cycloaliphatic polyesters.

Cyclohexanedicarboxylic acids and their chemical equivalents can be prepared, for example, by the hydrogenation of cycloaromatic diacids and corresponding derivatives such as isophthalic acid, terephthalic acid or naphthalenic acid in a suitable solvent, water or acetic acid at room temperature and at atmospheric pressure using suitable catalysts such as rhodium supported on a suitable carrier of carbon or alumina. They may also be prepared by the use of an inert liquid medium wherein an acid is at least partially soluble under reaction conditions and a catalyst of palladium or ruthenium in carbon or silica is used.

Typically, during hydrogenation, two or more isomers are obtained wherein the carboxylic acid groups are in either the cis- or trans-positions. The cis- and trans-isomers can be separated by crystallization with or without a solvent, for example, n-heptane, or by distillation. While the cis-isomer tends to blend better, the trans-isomer has higher melting and crystallization temperature and is generally preferred. Mixtures of the cis- and trans-isomers may also be used, and preferably when such a mixture is used, the trans-isomer will preferably comprise at least about 75 wt % and the cis-isomer will comprise the remainder based on the total weight of cis- and trans-isomers combined. When a mixture of isomers or more than one diacid is used, a copolyester or a mixture of two polyesters may be used as the cycloaliphatic polyester resin.

Chemical equivalents of these diacids including esters may also be used in the preparation of the cycloaliphatic polyesters. Suitable examples of the chemical equivalents of the diacids are alkyl esters, e.g., dialkyl esters, diaryl esters, anhydrides, acid chlorides, acid bromides, or the like, or combinations comprising at least one of the foregoing chemical equivalents. The preferred chemical equivalents comprise the dialkyl esters of the cycloaliphatic diacids, and the most preferred chemical equivalent comprises the dimethyl ester of the acid, particularly dimethyl-trans-1,4-cyclohexanedicarboxylate.

Dimethyl-1,4-cyclohexanedicarboxylate can be obtained by ring hydrogenation of dimethylterephthalate, wherein two isomers having the carboxylic acid groups in the cis- and trans-positions are obtained. The isomers can be separated, the trans-isomer being especially preferred. Mixtures of the isomers may also be used as detailed above.

The polyester polymers are generally obtained through the condensation or ester interchange polymerization of the polymer precursors such as diol or diol chemical equivalent component with the diacid or diacid chemical equivalent component and having recurring units of the formula (VIII): 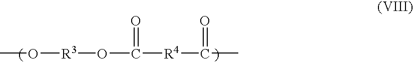
wherein R³ represents an alkyl or cycloalkyl radical containing 2 to 12 carbon atoms and which is the residue of a straight chain, branched, or cycloaliphatic alkane diol having 2 to 12 carbon atoms or chemical equivalents thereof; and R⁴ is an alkyl or a cycloaliphatic radical which is the decarboxylated residue derived from a diacid, with the proviso that at least one of R³ or R⁴ is a cycloalkyl group.

A preferred cycloaliphatic polyester is poly(1,4-cyclohexane-dimethanol-1,4-cyclohexanedicarboxylate) having recurring units of formula (IX) 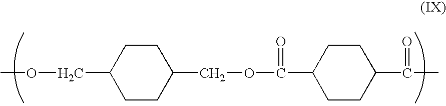
wherein in the formula (VIII), R³ is a cyclohexane ring, and wherein R⁴ is a cyclohexane ring derived from cyclohexanedicarboxylate or a chemical equivalent thereof and is selected from the cis- or trans-isomer or a mixture of cis- and trans-isomers thereof. Cycloaliphatic polyester polymers can be generally made in the presence of a suitable catalyst such as a tetra(2-ethyl hexyl)titanate, in a suitable amount, typically about 50 to 400 ppm of titanium based upon the total weight of the final product. Poly(1,4-cyclohexanedimethanol-1,4-cyclohexanedicarboxylate) generally forms a suitable blend with the polycarbonate. Aromatic polyesters or polyarylates may also be used in the conductive compositions.

Preferably, the number average molecular weight of the copolyestercarbonates or the polyesters is about 3,000 to about 1,000,000 g/mole. Within this range, it is desirable to have a number average molecular weight of greater than or equal to about 10,000, preferably greater than or equal to about 20,000, and more preferably greater than or equal to about 25,000 g/mole. Also desirable is a number average molecular weight of less than or equal to about 100,000, preferably less than or equal to about 75,000, more preferably less than or equal to about 50,000, and most preferably less than or equal to about 35,000 g/mole.

In another embodiment, the organic polymers include polystyrene. The term “polystyrene” as used herein includes polymers prepared by bulk, suspension and emulsion polymerization, which contain at least 25% by weight of polymer precursors having structural units derived from a monomer of the formula (X): 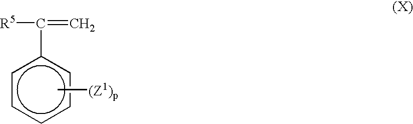
wherein R⁵ is hydrogen, lower alkyl or halogen; Z¹ is vinyl, halogen or lower alkyl; and p is from 0 to about 5. These organic polymers include homopolymers of styrene, chlorostyrene and vinyltoluene, random copolymers of styrene with one or more monomers illustrated by acrylonitrile, butadiene, alpha-methylstyrene, ethylvinylbenzene, divinylbenzene and maleic anhydride, and rubber-modified polystyrenes comprising blends and grafts, wherein the rubber is a polybutadiene or a rubbery copolymer of about 98 to about 70 wt % styrene and about 2 to about 30 wt % diene monomer. Polystyrenes are miscible with polyphenylene ether in all proportions, and any such blend may contain polystyrene in amounts of about 5 to about 95 wt % and most often about 25 to about 75 wt %, based on the total weight of the polymers.

In yet another embodiment, polyimides may be used as the organic polymers in the conductive compositions. Useful thermoplastic polyimides have the general formula (XI) 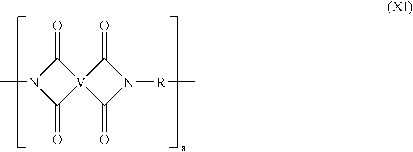
wherein a is greater than or equal to about 10, and more preferably greater than or equal to about 1000; and wherein V is a tetravalent linker without limitation, as long as the linker does not impede synthesis or use of the polyimide. Suitable linkers include (a) substituted or unsubstituted, saturated, unsaturated or aromatic monocyclic and polycyclic groups having about 5 to about 50 carbon atoms, (b) substituted or unsubstituted, linear or branched, saturated or unsaturated alkyl groups having 1 to about 30 carbon atoms; or combinations thereof. Suitable substitutions and/or linkers include, but are not limited to, ethers, epoxides, amides, esters, and combinations thereof. Preferred linkers include but are not limited to tetravalent aromatic radicals of formula (XII), such as 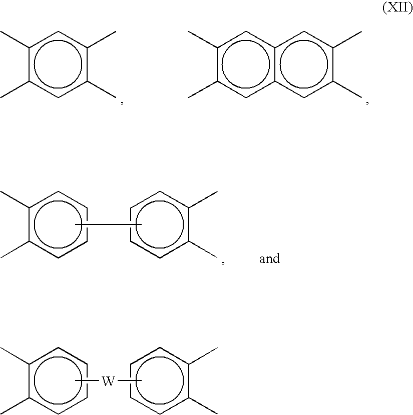
wherein W is a divalent moiety selected from the group consisting of —O—, —S—, —C(O)—, —SO₂—, —SO—, —C_{y}H_{2y}— (y being an integer from 1 to 5), and halogenated derivatives thereof, including perfluoroalkylene groups, or a group of the formula —O-Z-O— wherein the divalent bonds of the —O— or the —O-Z-O— group are in the 3,3′, 3,4′, 4,3′, or the 4,4′ positions, and wherein Z includes, but is not limited, to divalent radicals of formula (XIII). 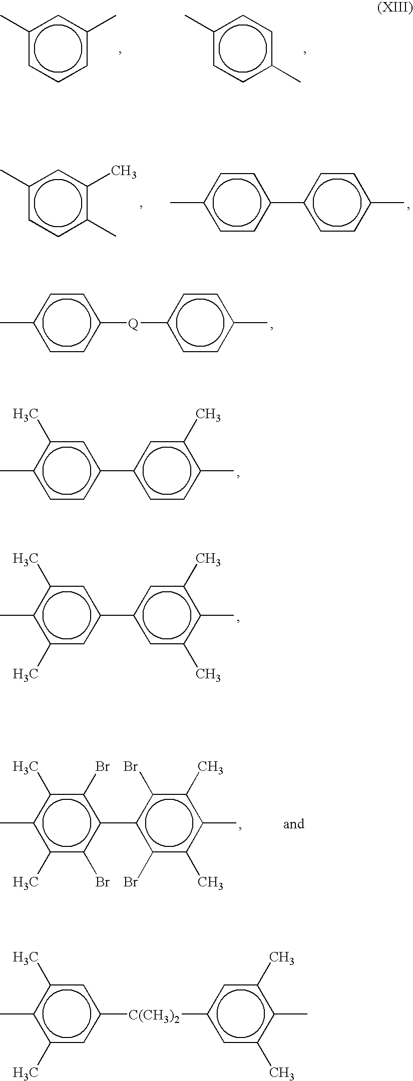
R in formula (XI) includes substituted or unsubstituted divalent organic radicals such as (a) aromatic hydrocarbon radicals having about 6 to about 20 carbon atoms and halogenated derivatives thereof; (b) straight or branched chain alkylene radicals having about 2 to about 20 carbon atoms; (c) cycloalkylene radicals having about 3 to about 20 carbon atoms, or (d) divalent radicals of the general formula (XIV) 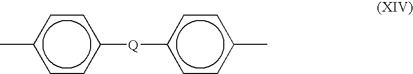
wherein Q includes a divalent moiety selected from the group consisting of —O—, —S—, —C(O)—, —SO₂—, —SO—, —C_{y}H_{2y}— (y being an integer from 1 to 5), and halogenated derivatives thereof, including perfluoroalkylene groups.

Preferred classes of polyimides that may be used in the conductive compositions include polyamidimides and polyetherimides, particularly those polyetherimides that are melt processable.

Preferred polyetherimide polymers comprise more than 1, preferably about 10 to about 1000 or more, and more preferably about 10 to about 500 structural units, of the formula (XV) 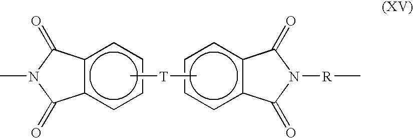
wherein T is —O— or a group of the formula —O-Z-O— wherein the divalent bonds of the —O— or the —O-Z-O— group are in the 3,3′, 3,4′, 4,3′, or the 4,4′ positions, and wherein Z includes, but is not limited, to divalent radicals of formula (XIII) as defined above.

In one embodiment, the polyetherimide may be a copolymer, which, in addition to the etherimide units described above, further contains polyimide structural units of the formula (XVI) 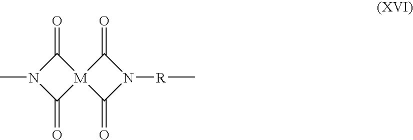
wherein R is as previously defined for formula (XI) and M includes, but is not limited to, radicals of formula (XVII).

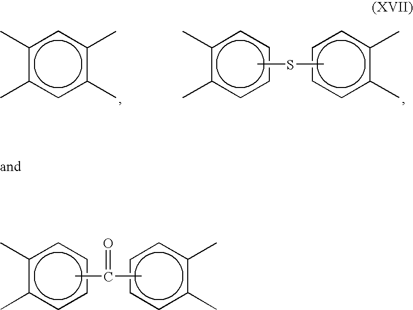

The polyetherimide can be prepared by any of the methods including the reaction of an aromatic bis(ether anhydride) of the formula (XVIII) 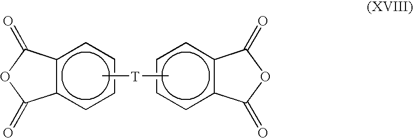
with an organic diamine of the formula (XIX)
H₂N—R—NH₂ (XIX)
wherein T and R are defined as described above in formulas (XI) and (XIV).

Illustrative examples of aromatic bis(ether anhydride)s of formula (XVIII) include 2,2-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride and 4-(2,3-dicarboxyphenoxy)-4′-(3,4-dicarboxyphenoxy)diphenyl sulfone dianhydride, as well as various mixtures thereof.

The bis(ether anhydride)s can be prepared by the hydrolysis, followed by dehydration, of the reaction product of a nitro substituted phenyl dinitrile with a metal salt of dihydric phenol compound in the presence of a dipolar, aprotic solvent. A preferred class of aromatic bis(ether anhydride)s included by formula (XVIII) above includes, but is not limited to, compounds wherein T is of the formula (XX) 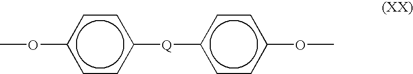
and the ether linkages, for example, are preferably in the 3,3′, 3,4′, 4,3′, or 4,4′ positions, and mixtures thereof, and where Q is as defined above.

Any diamino compound may be employed in the preparation of the polyimides and/or polyetherimides. Examples of suitable compounds are ethylenediamine, propylenediamine, trimethylenediamine, diethylenetriamine, triethylenetertramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(b-amino-t-butyl) toluene, bis(p-b-amino-t-butylphenyl) ether, bis(p-b-methyl-o-aminophenyl) benzene, bis(p-b-methyl-o-aminopentyl) benzene, 1,3-diamino-4-isopropylbenzene, bis(4-aminophenyl) sulfide, bis (4-aminophenyl) sulfone, bis(4-aminophenyl) ether and 1,3-bis(3-aminopropyl) tetramethyldisiloxane. Mixtures of these compounds may also be present. The preferred diamino compounds are aromatic diamines, especially m- and p-phenylenediamine and mixtures thereof.

In an exemplary embodiment, the polyetherimide resin comprises structural units according to formula (XV) wherein each R is independently p-phenylene or m-phenylene or a mixture thereof and T is a divalent radical of the formula (XXI)

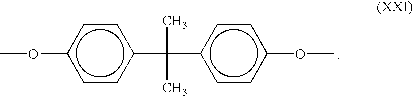

In general, the reactions can be carried out employing solvents such as o-dichlorobenzene, m-cresol/toluene, or the like, to effect a reaction between the anhydride of formula (XVIII) and the diamine of formula (XIX), at temperatures of about 100° C. to about 250° C. Alternatively, the polyetherimide can be prepared by melt polymerization of aromatic bis(ether anhydride)s of formula (XVIII) and diamines of formula (XIX) by heating a mixture of the starting materials to elevated temperatures with concurrent stirring. Generally, melt polymerizations employ temperatures of about 200° C. to about 400° C. Chain stoppers and branching agents may also be employed in the reaction. When polyetherimide/polyimide copolymers are employed, a dianhydride, such as pyromellitic anhydride, is used in combination with the bis(ether anhydride). The polyetherimide polymers can optionally be prepared from reaction of an aromatic bis(ether anhydride) with an organic diamine in which the diamine is present in the reaction mixture at no more than about 0.2 molar excess, and preferably less than about 0.2 molar excess. Under such conditions the polyetherimide resin has less than about 15 microequivalents per gram (μeq/g) acid titratable groups, and preferably less than about 10 μeq/g acid titratable groups, as shown by titration with chloroform solution with a solution of 33 weight percent (wt %) hydrobromic acid in glacial acetic acid. Acid-titratable groups are essentially due to amine end-groups in the polyetherimide resin.

Generally, useful polyetherimides have a melt index of about 0.1 to about 10 grams per minute (g/min), as measured by American Society for Testing Materials (ASTM) D1238 at 295° C., using a 6.6 kilogram (kg) weight. In a preferred embodiment, the polyetherimide resin has a weight average molecular weight (Mw) of about 10,000 to about 150,000 grams per mole (g/mole), as measured by gel permeation chromatography, using a polystyrene standard. Such polyetherimide polymers typically have an intrinsic viscosity greater than about 0.2 deciliters per gram (dl/g), preferably about 0.35 to about 0.7 dl/g measured in m-cresol at 25° C.

In yet another embodiment, polyamides may be used as the organic polymers in the conductive composition. Polyamides are generally derived from the polymerization of organic lactams having from 4 to 12 carbon atoms. Preferred lactams are represented by the formula (XXII) 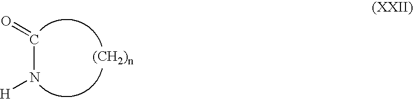
wherein n is about 3 to about 11. A highly preferred lactam is epsilon-caprolactam having n equal to 5.

Polyamides may also be synthesized from amino acids having from 4 to 12 carbon atoms. Preferred amino acids are represented by the formula (XXIII) 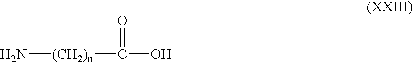
wherein n is about 3 to about 11. A highly preferred amino acid is epsilon-aminocaproic acid with n equal to 5.

Polyamides may also be polymerized from aliphatic dicarboxylic acids having from 4 to 12 carbon atoms and aliphatic diamines having from 2 to 12 carbon atoms. Suitable and preferred aliphatic dicarboxylic acids are the same as those described above for the synthesis of polyesters. Preferred aliphatic diamines are represented by the formula (XXIV)
H₂N—(CH₂)ₙ—NH₂ (XXIV)
wherein n is about 2 to about 12. A highly preferred aliphatic diamine is hexamethylenediamine (H₂N(CH₂)₆NH₂). It is preferred that the molar ratio of the dicarboxylic acid to the diamine be about 0.66 to about 1.5. Within this range it is generally desirable to have the molar ratio be greater than or equal to about 0.81, preferably greater than or equal to about 0.96. Also desirable within this range is an amount of less than or equal to about 1.22, preferably less than or equal to about 1.04. The preferred polyamides are nylon 6, nylon 6,6, nylon 4,6, nylon 6, 12, nylon 10, or the like, or combinations comprising at least one of the foregoing nylons.

Synthesis of polyamideesters may also be accomplished from aliphatic lactones having from 4 to 12 carbon atoms and aliphatic lactams having from 4 to 12 carbon atoms. The aliphatic lactones are the same as those described above for polyester synthesis, and the aliphatic lactams are the same as those described above for the synthesis of polyamides. The ratio of aliphatic lactone to aliphatic lactam may vary widely depending on the desired composition of the final copolymer, as well as the relative reactivity of the lactone and the lactam. A presently preferred initial molar ratio of aliphatic lactam to aliphatic lactone is about 0.5 to about 4. Within this range a molar ratio of greater than or equal to about 1 is desirable. Also desirable is a molar ratio of less than or equal to about 2.

The conductive precursor composition may further comprise a catalyst or an initiator. Generally, any known catalyst or initiator suitable for the corresponding thermal polymerization may be used. Alternatively, the polymerization may be conducted without a catalyst or initiator. For example, in the synthesis of polyamides from aliphatic dicarboxylic acids and aliphatic diamines, no catalyst is required.

For the synthesis of polyamides from lactams, suitable catalysts include water and the omega-amino acids corresponding to the ring-opened (hydrolyzed) lactam used in the synthesis. Other suitable catalysts include metallic aluminum alkylates (MAl(OR)₃H; wherein M is an alkali metal or alkaline earth metal, and R is C₁-C₁₂ alkyl), sodium dihydrobis(2-methoxyethoxy)aluminate, lithium dihydrobis(tert-butoxy)aluminate, aluminum alkylates (Al(OR)₂R; wherein R is C₁-C₁₂ alkyl), N-sodium caprolactam, magnesium chloride or bromide salt of epsilon-caprolactam (MgXC₆H₁₀NO, X═Br or Cl), dialkoxy aluminum hydride. Suitable initiators include isophthaloybiscaprolactam, N-acetalcaprolactam, isocyanate epsilon-caprolactam adducts, alcohols (ROH; wherein R is C₁-C₁₂ alkyl), diols (HO—R—OH; wherein R is R is C₁-C₁₂ alkylene), omega-aminocaproic acids, and sodium methoxide.

For the synthesis of polyamideesters from lactones and lactams, suitable catalysts include metal hydride compounds, such as a lithium aluminum hydride catalysts having the formula LiAl(H)ₓ(R¹)_{y}, where x is about 1 to about 4, y is about 0 to about 3, x+y is equal to 4, and R¹ is selected from the group consisting of C₁-C₁₂ alkyl and C₁-C₁₂ alkoxy; highly preferred catalysts include LiAl(H)(OR²)₃, wherein R² is selected from the group consisting of C₁-C₈ alkyl; an especially preferred catalyst is LiAl(H)(OC(CH₃)₃)₃. Other suitable catalysts and initiators include those described above for the polymerization of poly(epsilon-caprolactam) and poly(epsilon-caprolactone).

The organic polymer is generally present in amounts of about 5 to about 99.999 weight percent (wt %) in the conductive composition. Within this range, it is generally desirable use the organic polymer or the polymeric blend in an amount of greater than or equal to about 10 wt %, preferably greater or equal to about 30 wt %, and more preferably greater than or equal to about 50 wt % of the total weight of the composition. The organic polymers or polymeric blends are furthermore generally used in amounts less than or equal to about 99.99 wt %, preferably less than or equal to about 99.5 wt %, more preferably less than or equal to about 99.3 wt % of the total weight of the composition.

The nanosized conductive fillers are those having at least one dimension less than or equal to about 1,000 nm. The nanosized conductive fillers may be 1, 2 or 3-dimensional and may exist in the form of powder, drawn wires, strands, fibers, tubes, nanotubes, rods, whiskers, flakes, laminates, platelets, ellipsoids, discs, spheroids, and the like, or combinations comprising at least one of the foregoing forms. They may also have fractional dimensions and may exist in the form of mass or surface fractals.

Suitable examples of nanosized conductive fillers are single wall carbon nanotubes (SWNTs), multiwall carbon nanotubes (MWNTs), vapor grown carbon fibers (VGCF), carbon black, conductive metal particles, conductive metal oxides, metal coated fillers, and the like. In one embodiment, these nanosized conductive fillers may be added to the conductive composition during the polymerization of the polymeric precursor. In another embodiment, the nanosized conductive fillers are added to the organic polymer during manufacturing to form the conductive composition.

SWNTs used in the conductive composition may be produced by laser-evaporation of graphite, carbon arc synthesis or the high-pressure carbon monoxide conversion process (HIPCO) process. These SWNTs generally have a single wall comprising a graphene sheet with outer diameters of about 0.7 to about 2.4 nanometers (nm). SWNTs having aspect ratios of greater than or equal to about 5, preferably greater than or equal to about 100, more preferably greater than or equal to about 1000 are generally utilized in the compositions. While the SWNTs are generally closed structures having hemispherical caps at each end of the respective tubes, it is envisioned that SWNTs having a single open end or both open ends may also be used. The SWNTs generally comprise a central portion, which is hollow, but may be filled with amorphous carbon.

In one embodiment, the SWNTs may exist in the form of rope-like-aggregates. These aggregates are commonly termed “ropes” and are formed as a result of Van der Waal's forces between the individual SWNTs. The individual nanotubes in the ropes may slide against one another and rearrange themselves within the rope in order to minimize the free energy. Ropes generally having between 10 and 10⁵ nanotubes may be used in the compositions. Within this range, it is generally desirable to have ropes having greater than or equal to about 100, preferably greater than or equal to about 500 nanotubes. Also desirable, are ropes having less than or equal to about 10⁴ nanotubes, preferably less than or equal to about 5,000 nanotubes.

In yet another embodiment, it is desirable for the SWNT ropes to connect each other or with the stacks in the form of branches after dispersion. This results in a sharing of the ropes between the branches of the SWNT networks to form a 3-diminsional network in the organic polymer matrix. A distance of about 10 nm to about 10 micrometers may separate the branching points in this type of network. It is generally desirable for the SWNTs to have an inherent thermal conductivity of at least 2000 Watts per meter Kelvin (W/m-K) and for the SWNT ropes to have an inherent electrical conductivity of 10⁴ Siemens/centimeter (S/cm). It is also generally desirable for the SWNTs to have a tensile strength of at least 80 gigapascals (GPa) and a stiffness of at least about 0.5 tarapascals (TPa).

In another embodiment, the SWNTs may comprise a mixture of metallic nanotubes and semi-conducting nanotubes. Metallic nanotubes are those that display electrical characteristics similar to metals, while the semi-conducting nanotubes are those, which are electrically semi-conducting. In general the manner in which the graphene sheet is rolled up produces nanotubes of various helical structures. Zigzag and armchair nanotubes constitute two possible confirmations. In order to minimize the quantity of SWNTs utilized in the composition, it is generally desirable to have the composition comprise as large a fraction of metallic SWNTs. It is generally desirable for the SWNTs used in the composition to comprise metallic nanotubes in an amount of greater than or equal to about 1 wt %, preferably greater than or equal to about 20 wt %, more preferably greater than or equal to about 30 wt %, even more preferably greater than or equal to about 50 wt %, and most preferably greater than or equal to about 99.9 wt % of the total weight of the SWNTs. In certain situations, it is generally desirable for the SWNTs used in the conductive composition to comprise semi-conducting nanotubes in an amount of greater than or equal to about 1 wt %, preferably greater than or equal to about 20 wt %, more preferably greater than or equal to about 30 wt %, even more preferably greater than or equal to about 50 wt %, and most preferably greater than or equal to about 99.9 wt % of the total weight of the SWNTs.

If SWNTs are used, they are generally used in amounts of about 0.001 to about 80 wt % of the total weight of the composition when desirable. Within this range, SWNTs are generally used in amounts greater than or equal to about 0.25 wt %, preferably greater or equal to about 0.5 wt %, more preferably greater than or equal to about 1 wt % of the total weight of the composition. SWNTs are furthermore generally used in amounts less than or equal to about 30 wt %, preferably less than or equal to about 10 wt %, more preferably less than or equal to about 5 wt % of the total weight of the composition.

In one embodiment, the SWNTs may contain production related impurities. Production related impurities present in SWNTs as defined herein are those impurities, which are produced during processes substantially related to the production of SWNTs. As stated above, SWNTs are produced in processes such as, for example, laser ablation, chemical vapor deposition, carbon arc, high-pressure carbon monoxide conversion processes, or the like. Production related impurities are those impurities that are either formed naturally or formed deliberately during the production of SWNTs in the aforementioned processes or similar manufacturing processes. A suitable example of a production related impurity that is formed naturally are catalyst particles used in the production of the SWNTs. A suitable example of a production related impurity that is formed deliberately is a dangling bond formed on the surface of the SWNT by the deliberate addition of a small amount of an oxidizing agent during the manufacturing process.

Production related impurities include for example, carbonaceous reaction by-products such as defective SWNTs, multiwall carbon nanotubes, branched or coiled multiwall carbon nanotubes, amorphous carbon, soot, nano-onions, nanohoms, coke, or the like; catalytic residues from the catalysts utilized in the production process such as metals, metal oxides, metal carbides, metal nitrides or the like, or combinations comprising at least one of the foregoing reaction byproducts. A process that is substantially related to the production of SWNTs is one in which the fraction of SWNTs is larger when compared with any other fraction of production related impurities. In order for a process to be substantially related to the production of SWNTs, the fraction of SWNTs would have to be greater than a fraction of any one of the above listed reaction byproducts or catalytic residues. For example, the fraction of SWNTs would have to be greater than the fraction of multiwall nanotubes, or the fraction of soot, or the fraction of carbon black. The fraction of SWNTs would not have to be greater than the sums of the fractions of any combination of production related impurities for the process to be considered substantially directed to the production of SWNTs.

In general, the SWNTs used in the composition may comprise an amount of about 0.1 to about 80 wt % impurities. Within this range, the SWNTs may have an impurity content greater than or equal to about 1, preferably greater than or equal to about 3, preferably greater than or equal to about 7, and more preferably greater than or equal to about 8 wt %, of the total weight of the SWNTs. Also desirable within this range, is an impurity content of less than of equal to about 50, preferably less than or equal to about 45, and more preferably less than or equal to about 40 wt % of the total weight of the SWNTs.

In one embodiment, the SWNTs used in the composition may comprise an amount of about 0.1 to about 50 wt % catalytic residues. Within this range, the SWNTs may have a catalytic residue content greater than or equal to about 3, preferably greater than or equal to about 7, and more preferably greater than or equal to about 8 wt %, of the total weight of the SWNTs. Also desirable within this range, is a catalytic residue content of less than of equal to about 50, preferably less than or equal to about 45, and more preferably less than or equal to about 40 wt % of the total weight of the SWNTs.

MWNTs derived from processes such as laser ablation and carbon arc synthesis, which is not directed at the production of SWNTs, may also be used in the conductive compositions. MWNTs have at least two graphene layers bound around an inner hollow core. Hemispherical caps generally close both ends of the MWNTs, but it may desirable to use MWNTs having only one hemispherical cap or MWNTs, which are devoid of both caps. MWNTs generally have diameters of about 2 to about 50 nm. Within this range, it is generally desirable to use MWNTs having diameters less than or equal to about 40, preferably less than or equal to about 30, and more preferably less than or equal to about 20 nm. When MWNTs are used, it is preferred to have an average aspect ratio greater than or equal to about 5, preferably greater than or equal to about 100, more preferably greater than or equal to about 1000.

When MWNTs are used, they are generally used in amounts of about 0.001 to about 50 wt % of the total weight of the conductive composition. Within this range, MWNTs are generally used in amounts greater than or equal to about 0.25 wt %, preferably greater or equal to about 0.5 wt %, more preferably greater than or equal to about 1 wt % of the total weight of the conductive composition. MWNTs are furthermore generally used in amounts less than or equal to about 30 wt %, preferably less than or equal to about 10 wt %, more preferably less than or equal to about 5 wt % of the total weight of the conductive composition.

Vapor grown carbon fibers or small graphitic or partially graphitic carbon fibers, also referred to as vapor grown carbon fibers (VGCF), having diameters of about 3.5 to about 100 nanometers (nm) and an aspect ratio greater than or equal to about 5 may also be used. When VGCF are used, diameters of about 3.5 to about 70 nm are preferred, with diameters of about 3.5 to about 50 nm being more preferred, and diameters of about 3.5 to about 25 nm most preferred. It is also preferable to have average aspect ratios greater than or equal to about 100 and more preferably greater than or equal to about 1000.

VGCF, when used, are generally used in amounts of about 0.001 to about 50 wt % of the total weight of the conductive composition when desirable. Within this range, VGCF are generally used in amounts greater than or equal to about 0.25 wt %, preferably greater or equal to about 0.5 wt %, more preferably greater than or equal to about 1 wt % of the conductive composition. VGCF are furthermore generally used in amounts less than or equal to about 30 wt %, preferably less than or equal to about 10 wt %, more preferably less than or equal to about 5 wt % of the conductive composition.

Both the SWNTs and the other carbon nanotubes (i.e., the MWNTs and the VGCF) utilized in the conductive composition may also be derivatized with functional groups to improve compatibility and facilitate the mixing with the organic polymer. The SWNTs and the other carbon nanotubes may be functionalized on either the graphene sheet constituting the sidewall, a hemispherical cap or on both the side wall as well as the hemispherical endcap. Functionalized SWNTs and the other carbon nanotubes are those having the formula (XXV)
[CₙH_{L}Rₘ (XXV)
wherein n is an integer, L is a number less than 0.1n, m is a number less than 0.5n, and wherein each of R is the same and is selected from —SO₃H, —NH₂, —OH, —C(OH)R′, —CHO, —CN, —C(O)Cl, —C(O)SH, —C(O)OR′, —SR′, —SiR₃′, —Si(OR)_{y}R′_{(3-y)}, —R″, —AlR₂′, halide, ethylenically unsaturated functionalities, epoxide functionalities, or the like, wherein y is an integer equal to or less than 3, R′ is hydrogen, alkyl, aryl, cycloalkyl, alkaryl, aralkyl, cycloaryl, poly(alkylether), bromo, chloro, iodo, fluoro, amino, hydroxyl, thio, phosphino, alkylthio, cyano, nitro, amido, carboxyl, heterocyclyl, ferrocenyl, heteroaryl, fluoro substituted alkyl, ester, ketone, carboxylic acid, alcohol, fluoro-substituted carboxylic acid, fluoro-alkyl-triflate, or the like, and R″ is fluoroalkyl, fluoroaryl, fluorocycloalkyl, fluoroaralkyl, cycloaryl, or the like. The carbon atoms, Cₙ, are surface carbons of a carbon nanotube. In both, uniformly and non-uniformly substituted SWNTs and other carbon nanotubes, the surface atoms Cₙ are reacted.

Non-uniformly substituted SWNTs and other carbon nanotubes may also be used in the conductive composition. These include compositions of the formula (I) shown above wherein n, L, m, R and the SWNT itself are as defined above, provided that each of R does not contain oxygen, or, if each of R is an oxygen-containing group, COOH is not present.

Also included are functionalized SWNTs and other carbon nanotubes having the formula (XXVI)
[CₙH_{L}R″—R]ₘ (XXVI)
where n, L, m, R′ and R have the same meaning as above. Most carbon atoms in the surface layer of a carbon nanotube are basal plane carbons. Basal plane carbons are relatively inert to chemical attack. At defect sites, where, for example, the graphitic plane fails to extend fully around the carbon nanotube, there are carbon atoms analogous to the edge carbon atoms of a graphite plane. The edge carbons are reactive and must contain some heteroatom or group to satisfy carbon valency.

The substituted SWNTs and other carbon nanotubes described above may advantageously be further functionalized. Such SWNT compositions include compositions of the formula (XXVII)
[CₙH_{L}Aₘ (XXVII)
where n, L and m are as described above, A is selected from —OY, —NHY, —CR′₂—OY, —C(O)OY, —C(O)NR′Y, —C(O)SY, or —C(O)Y, wherein Y is an appropriate functional group of a protein, a peptide, an enzyme, an antibody, a nucleotide, an oligonucleotide, an antigen, or an enzyme substrate, enzyme inhibitor or the transition state analog of an enzyme substrate or is selected from —R′OH, —RNH₂, —R′SH, —R′CHO, —R′CN, —R′X, —R′SiR′₃, —RSi′(OR′)_{y}—R′_{(3-y)}, —R′Si′(O′SiR′₂)—OR′, —R′—R″, —R′—NCO, (C₂H₄ O)_{w}Y, —(C₃H₆O)_{w}H, —(C₂H₄O)_{w}R′, —(C₃H₆O)_{w}R′ and R″, wherein w is an integer greater than one and less than 200.

The functional SWNTs and other carbon nanotubes of structure (XXVI) may also be functionalized to produce SWNT compositions having the formula (XXVIII)
[CₙH_{L}R′-A]ₘ (XXVIII)
where n, L, m, R′ and A are as defined above.

The conductive composition may also include SWNTs and other carbon nanotubes upon which certain cyclic compounds are adsorbed. These include SWNT compositions of matter of the formula (XXIX)
[CₙH_{L}X—Rₐ]ₘ (XXIX)
where n is an integer, L is a number less than 0.1n, m is less than 0.5n, a is zero or a number less than 10, X is a polynuclear aromatic, polyheteronuclear aromatic or metallopolyheteronuclear aromatic moiety and R is as recited above. Preferred cyclic compounds are planar macrocycles such as re porphyrins and phthalocyanines.

The adsorbed cyclic compounds may be functionalized. Such SWNT compositions include compounds of the formula (XXX)
[CₙH_{L}X-Aₐ]ₘ (XXX)
where m, n, L, a, X and A are as defined above and the carbons are on the SWNT or on other nanotubes such as MWNTs, VGCF, or the like.

Without being bound to a particular theory, the functionalized SWNTs and other carbon nanotubes are better dispersed into the organic polymers because the modified surface properties may render the carbon nanotube more compatible with the organic polymer, or, because the modified functional groups (particularly hydroxyl or amine groups) are bonded directly to the organic polymer as terminal groups. In this way, organic polymers such as polycarbonates, polyamides, polyesters, polyetherimides, or the like, bond directly to the carbon nanotubes, thus making the carbon nanotubes easier to disperse with improved adherence to the organic polymer.

Functional groups may generally be introduced onto the outer surface of the SWNTs and the other carbon nanotubes by contacting the respective outer surfaces with a strong oxidizing agent for a period of time sufficient to oxidize the surface of the SWNTs and other carbon nanotubes and further contacting the respective outer surfaces with a reactant suitable for adding a functional group to the oxidized surface. Preferred oxidizing agents are comprised of a solution of an alkali metal chlorate in a strong acid. Preferred alkali metal chlorates are sodium chlorate or potassium chlorate. A preferred strong acid used is sulfuric acid. Periods of time sufficient for oxidation are about 0.5 hours to about 24 hours.

Carbon black may also be used in the conductive composition. Preferred carbon blacks are those having average particle sizes less than about 100 nm, preferably less than about 70 nm, more preferably less than about 50 nm. Preferred conductive carbon blacks may also have surface areas greater than about 200 square meter per gram (m²/g), preferably greater than about 400 m²/g, yet more preferably greater than about 1000 m²/g. Preferred conductive carbon blacks may have a pore volume (dibutyl phthalate absorption) greater than about 40 cubic centimeters per hundred grams (cm³/100 g), preferably greater than about 100 cm³/100 g, more preferably greater than about 150 cm³/100 g. Exemplary carbon blacks include the carbon black commercially available from Columbian Chemicals under the trade name CONDUCTEX®; the acetylene black available from Chevron Chemical, under the trade names S.C.F. (Super Conductive Furnace) and E.C.F. (Electric Conductive Furnace); the carbon blacks available from Cabot Corp. under the trade names VULCAN XC72 and BLACK PEARLS; and the carbon blacks commercially available from Akzo Co. Ltd under the trade names KETJEN BLACK EC 300 and EC 600. Preferred conductive carbon blacks may be used in amounts from about 2 wt % to about 25 wt % based on the total weight of the conductive precursor composition and/or the conductive composition.

Carbon black is generally used in amounts of about 0.001 to about 80 wt % of the total weight of the composition when desirable. Within this range, carbon black is generally used in amounts greater than or equal to about 0.25 wt %, preferably greater or equal to about 0.5 wt %, more preferably greater than or equal to about 1 wt % of the total weight of the composition. Carbon blacks are furthermore generally used in amounts less than or equal to about 30 wt %, preferably less than or equal to about 10 wt %, more preferably less than or equal to about 5 wt % of the total weight of the composition.

Solid conductive metallic fillers may also be used in the conductive composition. These may be electrically conductive metals or alloys that do not melt under conditions used in incorporating them into the organic polymer, and fabricating finished articles therefrom. Metals such as aluminum, copper, magnesium, chromium, tin, nickel, silver, iron, titanium, and mixtures comprising any one of the foregoing metals can be incorporated into the organic polymer as conductive fillers. Physical mixtures and true alloys such as stainless steels, bronzes, and the like, may also serve as conductive filler particles. In addition, a few intermetallic chemical compounds such as borides, carbides, and the like, of these metals, (e.g., titanium diboride) may also serve as conductive filler particles. Solid non-metallic, conductive filler particles such as tin-oxide, indium tin oxide, and the like may also be added to render the organic polymer conductive.

Non-conductive, non-metallic fillers that have been coated over a substantial portion of their surface with a coherent layer of solid conductive metal may also be used in the conductive composition. The non-conductive, non-metallic fillers are commonly referred to as substrates, and substrates coated with a layer of solid conductive metal may be referred to as “metal coated fillers”. Typical conductive metals such as aluminum, copper, magnesium, chromium, tin, nickel, silver, iron, titanium, and mixtures comprising any one of the foregoing metals may be used to coat the substrates. Non-limiting examples of such substrates include silica powder, such as fused silica and crystalline silica, boron-nitride powder, boron-silicate powders, alumina, magnesium oxide (or magnesia), wollastonite, including surface-treated wollastonite, calcium sulfate (as its anhydride, dihydrate or trihydrate), calcium carbonate, including chalk, limestone, marble and synthetic, precipitated calcium carbonates, generally in the form of a ground particulates, talc, including fibrous, modular, needle shaped, and lamellar talc, glass spheres, both hollow and solid, kaolin, including hard, soft, calcined kaolin, and kaolin comprising various coatings known in the art to facilitate compatibility with the polymeric matrix resin, mica, feldspar, silicate spheres, flue dust, cenospheres, fillite, aluminosilicate (armospheres), natural silica sand, quartz, quartzite, perlite, tripoli, diatomaceous earth, synthetic silica, and mixtures comprising any one of the foregoing. All of the above substrates may be coated with a layer of metallic material for use in the conductive composition.

Regardless of the exact size, shape and composition of the solid metallic and non-metallic conductive filler particles, they may be dispersed into the organic polymer at loadings of about 0.001 to about 50 wt % of the total weight of the conductive composition when desired. Within this range it is generally desirable to have the solid metallic and non-metallic conductive filler particles in an amount of greater than or equal to about 1 wt %, preferably greater than or equal to about 1.5 wt % and more preferably greater than or equal to about 2 wt % of the total weight of the conductive composition. The loadings of the solid metallic and non-metallic conductive filler particles may be less than or equal to 40 wt %, preferably less than or equal to about 30 wt %, more preferably less than or equal to about 25 wt % of the total weight of the conductive composition.

Various types of conductive carbon fibers are known in the art, and may be classified according to their diameter, morphology, and degree of graphitization (morphology and degree of graphitization being interrelated). These characteristics are presently determined by the method used to synthesize the carbon fiber. For example, carbon fibers having diameters down to about 5 micrometers, and graphene ribbons parallel to the fiber axis (in radial, planar, or circumferential arrangements) are produced commercially by pyrolysis of organic precursors in fibrous form, including phenolics, polyacrylonitrile (PAN), or pitch. These types of fibers have a relatively lower degree of graphitization. The carbon fibers generally have a diameter of greater than or equal to about 1,000 nanometers (1 micrometer) to about 15 micrometers. Within this range fibers having sizes of greater than or equal to about 2, preferably greater than or equal to about 3, and more preferably greater than or equal to about 4 micrometers may be advantageously used. Also desirable within this range are fibers having diameters of less than or equal to about 14, preferably less than or equal to about 12, and more preferably less than or equal to about 11 micrometers.

Graphite employed in the conductive compositions may be synthetically produced or naturally produced. Preferred graphites are those that are naturally produced. There are three types of naturally produced graphite that are commercially available. They are flake, amorphous graphite and crystal vein.

Flake graphite as indicated by the name has a flaky morphology. Flakes generally have a carbon concentration of about 5 to about 40 wt % graphite based on the flake composition. Flake graphite may be used in sizes of about 3 micrometers to about 10 millimeters. Amorphous graphite is not truly amorphous as its name suggests but is actually crystalline. Amorphous graphite has a microcrystalline. Amorphous graphite is available in average sizes of about 5 micrometers to about 10 centimeters. Preferred sizes are about 5 micrometers to about 5 millimeters. Crystal vein graphite generally has a vein like appearance on its outer surface from which it derives its name. Crystal vein graphite is commercially available in the form of flakes from Ashbury Carbons.

The graphite generally has average particle sizes (radii of gyration) of about 1 to about 5,000 micrometers. Within this range graphite particles having sizes of greater than or equal to about 3, preferably greater than or equal to about 5 micrometers may be advantageously used. Also desirable are graphite particles having sizes of less than or equal to about 4,000, preferably less than or equal to about 3,000, and more preferably less than or equal to about 2,000 micrometers. The graphite is generally flake like with an aspect ratio greater than or equal to about 2, preferably greater than or equal to about 5, more preferably greater than or equal to about 10, and even more preferably greater than or equal to about 50.

The graphite is generally used in amounts of greater than or equal to about 40 wt % to about 90 wt % of the total weight of the conductive composition. Within this range, graphite is generally used in amounts greater than or equal to about 52 wt %, preferably greater or equal to about 54 wt %, more preferably greater than or equal to about 56 wt % of the total weight of the conductive composition. The graphite is furthermore generally used in amounts less than or equal to about 85 wt %, preferably less than or equal to about 83 wt %, more preferably less than or equal to about 80 wt % of the total weight of the conductive composition. An exemplary amount of graphite is about 66 to about 69 wt % of the total weight of the conductive composition.

The organic polymer together with the graphite and the nanosized conductive filler may generally be processed in several different ways such as, melt blending, solution blending, or the like, or combinations comprising at least one of the foregoing methods of blending. Melt blending of the composition involves the use of shear force, extensional force, compressive force, ultrasonic energy, electromagnetic energy, thermal energy or combinations comprising at least one of the foregoing forces or forms of energy and is conducted in processing equipment wherein the aforementioned forces are exerted by a single screw, multiple screws, intermeshing co-rotating or counter rotating screws, non-intermeshing co-rotating or counter rotating screws, reciprocating screws, screws with pins, screws with screens, barrels with pins, rolls, rams, helical rotors, or combinations comprising at least one of the foregoing.

Melt blending involving the aforementioned forces may be conducted in machines such as, but not limited to single or multiple screw extruders, Buss kneader, Henschel, helicones, Ross mixer, Banbury, roll mills, molding machines such as injection molding machines, vacuum forming machines, blow molding machine, or then like, or combinations comprising at least one of the foregoing machines.

In one embodiment, the organic polymer in powder form, pellet form, sheet form, or the like, may be first dry blended with the graphite and the nanosized conductive filler if desired in a Henschel or in a roll mill, prior to being fed into a melt blending device such as an extruder or Buss kneader. While it is generally desirable for the shear forces in the melt blending device to generally cause a dispersion of the graphite and the nanosized conductive filler in the organic polymer, it is also desired to preserve the aspect ratio of the vapor grown carbon fibers, the SWNTs, the MWNTs and the graphite during the melt blending process. In order to do so, it may be desirable to introduce the graphite and the nanosized conductive filler into the melt blending device in the form of a masterbatch. In such a process, the masterbatch may be introduced into the melt blending device downstream of the point where the organic polymer is introduced.

A melt blend is one where at least a portion of the organic polymer has reached a temperature greater than or equal to about the melting temperature, if the resin is a semi-crystalline organic polymer, or the flow point (e.g., the glass transition temperature) if the resin is an amorphous resin during the blending process. A dry blend is one where the entire mass of organic polymer is at a temperature less than or equal to about the melting temperature if the resin is a semi-crystalline organic polymer, or at a temperature less than or equal to the flow point if the organic polymer is an amorphous resin and wherein organic polymer is substantially free of any liquid-like fluid during the blending process. A solution blend, as defined herein, is one where the organic polymer is suspended in a liquid-like fluid such as, for example, a solvent or a non-solvent during the blending process.

When a masterbatch is used, the graphite and/or the nanosized conductive filler may be present in the masterbatch in an amount of about 0.5 to about 50 wt %. Within this range, it is generally desirable to use graphite and the nanosized conductive filler in an amount of greater than or equal to about 1.5 wt %, preferably greater or equal to about 2 wt %, more preferably greater than or equal to about 2.5 wt % of the total weight of the masterbatch. Also desirable are graphite and the nanosized conductive filler in an amount of less than or equal to about 30 wt %, preferably less than or equal to about 10 wt %, more preferably less than or equal to about 5 wt % of the total weight of the masterbatch. In one embodiment pertaining to the use of masterbatches, while the masterbatch containing the graphite and the nanosized conductive filler may not have a measurable bulk or surface resistivity either when extruded in the form of a strand or molded into the form of dogbone, the resulting composition into which the masterbatch is incorporated has a measurable bulk or surface resistivity, even though the weight fraction of the graphite and the nanosized conductive filler in the conductive composition is lower than that in the masterbatch. It is preferable for the organic polymer in such a masterbatch to be semi-crystalline. Examples of semi-crystalline organic polymers which display these characteristics and which may be used in masterbatches are polypropylene, polyamides, polyesters, or the like, or combinations comprising at least on of the foregoing semi-crystalline organic polymers.

In another embodiment relating to the use of masterbatches in the manufacture of a conductive composition comprising a blend of organic polymers, it is sometimes desirable to have the masterbatch comprising an organic polymer that is the same as the organic polymer that forms the continuous phase of the composition. This feature permits the use of substantially smaller proportions of the graphite and the nanosized conductive filler, since only the continuous phase carries the graphite and the nanosized conductive filler that provides the conductive composition with the requisite volume and surface resistivity. In yet another embodiment relating to the use of masterbatches in polymeric blends, it may be desirable to have the masterbatch comprising an organic polymer that is different in chemistry from other the organic polymers that are used in the composition. In this case, the organic polymer of the masterbatch will form the continuous phase in the blend. In yet another embodiment, it may be desirable to use a separate masterbatch comprising multiwall nanotubes, vapor grown carbon fibers, carbon black, conductive metallic fillers, solid non-metallic, conductive fillers, or the like, or combinations comprising at least one of the foregoing in the composition.

The conductive composition comprising the organic polymer and the graphite and the nanosized conductive filler may be subject to multiple blending and forming steps if desirable. For example, the composition may first be extruded and formed into pellets. The pellets may then be fed into a molding machine where it may be formed into other desirable shapes such as housing for computers, automotive panels that can be electrostatically painted, or the like. Alternatively, the composition emanating from a single melt blender may be formed into sheets or strands and subjected to post-extrusion processes such as annealing, uniaxial or biaxial orientation.

Solution blending may also be used to manufacture the composition. The solution blending may also use additional energy such as shear, compression, ultrasonic vibration, or the like, to promote homogenization of the graphite and the nanosized conductive filler with the organic polymer. In one embodiment, an organic polymer suspended in a fluid may be introduced into an ultrasonic sonicator along with the graphite and the nanosized conductive filler. The mixture may be solution blended by sonication for a time period effective to disperse the graphite and the nanosized conductive filler onto the organic polymer particles. The organic polymer along with the graphite and the nanosized conductive filler may then be dried, extruded and molded if desired. It is generally desirable for the fluid to swell the organic polymer during the process of sonication. Swelling the organic polymer generally improves the ability of the graphite and the nanosized conductive filler to impregnate the organic polymer during the solution blending process and consequently improves dispersion.

In another embodiment related to solution blending, the graphite and the nanosized conductive filler is sonicated together with organic polymer precursors. Organic polymer precursors can be monomers, dimers, trimers, or the like, which can be reacted to form organic polymers. A fluid such as a solvent may optionally be introduced into the sonicator with the graphite and the nanosized conductive filler and the organic polymer precursor. The time period for the sonication is generally an amount effective to promote encapsulation of the graphite and the nanosized conductive filler by the organic polymer precursor. After the encapsulation, the organic polymer precursor is then polymerized to form an organic polymer within which is dispersed the graphite and the nanosized conductive filler. This method of dispersion of the graphite and the nanosized conductive filler into organic polymer promotes the preservation of the aspect ratios of nanosized conductive filler, which therefore permits the conductive composition to develop electrical conductivity at lower loadings of the graphite and the nanosized conductive filler. Alternatively, the polymerized resin containing encapsulated graphite and the nanosized conductive filler may be used as a masterbatch, i.e., blended with further organic polymer. In still another embodiment, a mixture of organic polymer, organic polymer precursor, optional fluid, graphite and/or the nanosized conductive filler is sonicated to encapsulate the graphite and/or the nanosized conductive filler, followed by polymerization of the organic polymer precursor.

Suitable examples of organic polymer precursors that may be used to facilitate this method of encapsulation and dispersion are those used in the synthesis of thermoplastic resins such as, but not limited to polyacetals, polyacrylics, polycarbonates, polystyrenes, polyesters, polyamides, polyamideimides, polyarylates, polyurethanes, polyarylsulfones, polyethersulfones, polyarylene sulfides, polyvinyl chlorides, polysulfones, polyetherimides, polytetrafluoroethylenes, polyetherketones, polyether etherketones, or the like. In general, it is desirable to sonicate the above-described mixtures for about 1 minute to about 24 hours. Within this range, it is desirable to sonicate the mixture for a period of greater than or equal to about 5 minutes, preferably greater than or equal to about 10 minutes and more preferably greater than or equal to about 15 minutes. Also desirable within this range is a time period of less than or equal to about 15 hours, preferably less than or equal to about 10 hours, and more preferably less than or equal to about 5 hours.

Despite the large filler content, these compositions are advantageously injection moldable. This is a feature not afforded by other compositions having similar weight fractions of other types of electrically conductive fillers. The ability to injection mold these compositions advantageously permits the manufacture of parts that have complex shapes, and for which a smooth surface finish is desirable.

These conductive compositions may be used in applications where there is a need for a superior balance of flow, impact, and conductivity. The conductive compositions described above may be used in a wide variety of commercial applications. They may be advantageously used where resistive heating is desired such as in walls of appliances such as refrigerators, wings of airplanes, heating elements for electrically heated blankets, fuel cells bipolar/end plates, plastic wires, heating elements with or without positive temperature coefficient for resistivity and other applications requiring injection moldable parts with electrical conductivity of about 1 to about 30 S/cm, outside rear-view mirror and fuel heaters in automobiles. They may also be used advantageously in automotive body panels both for interior and exterior components of automobiles that can be electrostatically painted if desired.

The following examples, which are meant to be exemplary, not limiting, illustrate compositions and methods of manufacturing of some of the various embodiments of the electrically conductive compositions described herein.

### EXAMPLES

### Example 1

This example was undertaken to demonstrate a synergy between the graphite and the nanosized dispersion fillers. In this example, a polycarbonate resin PC-175 commercially available from GE Plastics having a number average molecular weight of about 20,279 grams/mole and a weight average molecular weight of M_{w} about 45,009 grams/mole was blended with either graphite or a mixture of graphite or nanosized conductive fillers in a twin-screw extruder. The graphite was crystal vein graphite commercially available from Ashbury. The nanosized conductive fillers were either KETJEN BLACK commercially available from Akzo or multiwall carbon nanotubes (PR24PS or PR1HT) commercially available from Applied Sciences. Table 1 shows the compositions of the various samples that were tested.

TABLE 1

| | Graphite | | Multiwall Carbon |
|---|---|---|---|
| Sample # | (wt %) | Carbon black (wt %) | Nanotubes (wt %) |
| 1 | 70 | | |
| 2 | 69 | 1 | |
| 3 | 68 | 2 | |
| 4 | 66 | | 4* |
| 5 | 66 | | 4** |

*= PR24PS;
**= PR1HT

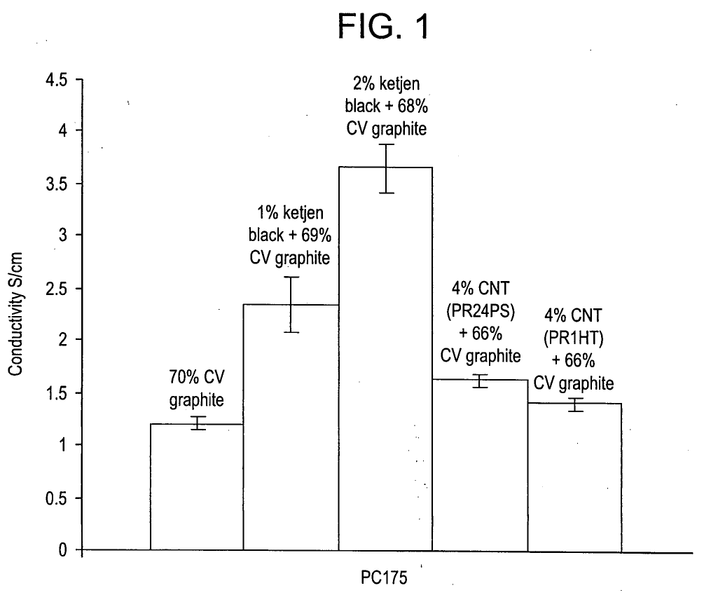

From the table it may be seen that the samples all contain a total amount of about 70 wt % electrically conductive filler (i.e., graphite and the nanosized dispersion filler). The composites were generated in a 30 mm diameter Buss Kneader. The extruder screw speed was set at 250 rpm. The extruder temperature was in the range of 150C to 280° C. The samples in shape of bars (dimension: 80 mm×10 mm×4 mm) were molded in a 85T injection molding machine. Electrical volume conductivity of the samples, reported in Siemens per centimeter (S/cm), was measured on such samples by the linear four probe method, using Keithley constant current source and voltmeter with maximum current of 50 milli Amperes (mA). The results are shown in the FIG. 1. FIG. 1 depicts a bar graph that compares the electrical volume resistivity measurements for the various samples of Table 1. From the figure it may be seen that the samples containing a combination of the graphite and the nanosized conductive filler have superior electrical properties (better conductivity) than those samples that contained only the graphite. Further it may be seen that samples containing the 68 wt % graphite and the 2 wt % carbon black (Sample 3) display an electrical conductivity that is at least over 100% superior in their electrical properties over Sample 1 which contains only the graphite. The results also clearly show that the addition of a very small amount of the nanosized conductive filler has a pronounced effect on the electrically conductive properties of the conductive composition.

### EXAMPLE 2

This example was undertaken to demonstrate the effect of using different organic polymer as the matrix in the highly filled systems. The compositions are shown in Table 2. From the Table 2 it may be seen that the organic polymers are polycarbonate (PC175), polyamide (PA6), high density polyethylene (HDPE), and polyvinylidene fluoride (PVDF). The graphite used was either crystal vein graphite (CVG) or natural flake graphite (NFG) both commercially available from Ashbury. The comparative examples shown with an asterisk (*) next to them were those samples that contained either no carbon or too much carbon.

TABLE 2

| | | Graphite | Graphite | Carbon | Carbon | Conductivity | Injection |
|---|---|---|---|---|---|---|---|
| Samples | Polymer | (wt %) | Type | (wt %) | Type | S/cm | Moldability |
| 1* | PC175 | 70 | CVG | 0 | — | 1.2 | Yes |
| 2 | PC175 | 69 | CVG | 1 | Ketjen | 2.4 | Yes |
| 3 | PC175 | 68 | CVG | 2 | Ketjen | 3.7 | Yes |
| 4 | PC175 | 66 | CVG | 4 | Ketjen | 10.9 | Yes |
| 5* | PC175 | 80 | CVG | 0 | — | 4.5 | Yes |
| 6 | PC175 | 78.7 | CVG | 1.3 | Ketjen | 11.0 | Yes |
| 7* | PA 6 | 70 | CVG | 0 | — | 0.3 | Yes |
| 8 | PA 6 | 67.7 | CVG | 2.3 | Ketjen | 3.4 | Yes |
| 9 | PA 6 | 65.4 | CVG | 4.6 | Ketjen | 19.2 | Yes |
| 10* | PA 6 | 80 | CVG | 0 | — | 1.2 | Yes |
| 11 | PA 6 | 79 | CVG | 0.85 | Ketjen | 9.9 | Yes |
| 12* | PA 6 | 78.3 | CVG | 1.7 | Ketjen | 24.0 | No (+) |
| 13 | PA 6 | 78.3 | NFG | 1.7 | Ketjen | 16.5 | Yes |
| 14 | PA 6 | 78.3 | CVG | 1.7 | Printex | 19.7 | Yes |
| 15 | PA 6 | 75.5 | CVG | 4.5 | Carbon | 14.4 | Yes |
| | | | | | Fiber | | |
| 16 | PA 6 | 70 | CVG | 10 | Carbon | 22.2 | Yes |
| | | | | | Fiber | | |
| 17 | PA 6 | 75.5 | CVG | 5 | Graphite | 19.0 | Yes |
| | | | | | Fiber | | |
| 18 | PA 6 | 70 | CVG | 15 | Carbon | — | No |
| | | | | | Fiber | | |
| 19 | PA 6 | 59.5 | CVG | 5.5 | Ketjen | 10.0 | Yes |
| 20 | PA 6 | 55 | CVG | 9 | Ketjen | 26.0 | Yes |
| 21* | PA 6 | 70 | CVG | 10 | Graphite | — | No |
| | | | | | Fiber | | |
| 22* | HDPE | 70 | CVG | 0 | — | 0.3 | Yes |
| 23 | HDPE | 66 | CVG | 4 | Ketjen | 1.9 | Yes |
| 24* | PVDF | 60 | CVG | 0 | — | 1.1 | Yes |
| 25 | PVDF | 58 | CVG | 2 | Ketjen | 1.6 | Yes |

*Comparative examples

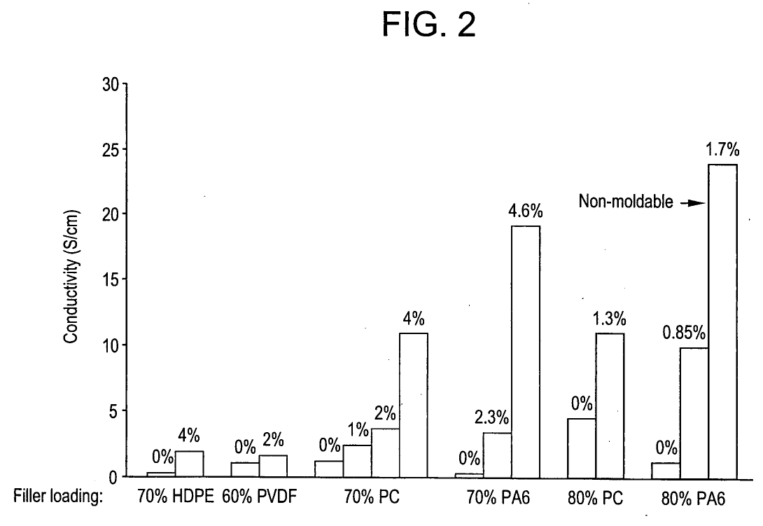

The samples were prepared and their conductivities were measured as detailed in example 1. The results are shown in the FIG. 2.

From the FIG. 2, it may be seen that those samples made with polyamide show a greater synergy between the organic polymer, the nanosized conductive filler and the graphite. From the examples 1 and 2 it may be seen that in highly filled graphite conductive compositions use of small amount of carbon increases the conductivity substantially. Useful conductivity (greater than or equal to about 10 siemens/cm) can be obtained at total filler loading of greater than or equal to about 55 wt. %. The range of nanosized conductive filler and/or the carbon fibers to graphite ratio is about 1:6 to 1:80. Within this range it is generally desirable to have the ratio of the nanosized conductive filler and/or the carbon fibers to the graphite to be less than or equal to about 1:8, preferably less than or equal to about 1:9, preferably less than or equal to about 1:10, preferably less than or equal to about 1:15, more preferably less than or equal to about 1:20, and more preferably less than or equal to about 1:40, and even more preferably less than or equal to about 1:60.

The conductive compositions are injection moldable and have melt viscosities of about 100 to about 600 Pascal-seconds (Pa-s) at 1500 sec⁻¹ as may be seen from the Table 3. Within this range, a melt viscosity of greater than or equal to about 150, preferably greater than or equal to about 200 Pa-s may be used. Also desirable is a melt viscosity of less than or equal to about 575, preferably less than or equal to about 550, and more preferably 500 Pa-s.

TABLE 3

| | | Ratio | | | |
|---|---|---|---|---|---|
| | | (Graphite/Filler | | | Shear |
| | | and/or Carbon | Conductivity | Viscosity | Stress |
| Sample # | Formulation | fiber) | (S/cm) | (Pa-s) | Pa |
| 7 | 70% CVG | — | 0.3 | 188 | 282481 |
| 8 | 68% CVG + 2% Ketjen | 34/1 | 3.4 | 192 | 287392 |
| 9 | 66% CVG + 4% Ketjen | 16.5/1 | 19.2 | 523 | 785217 |
| 10 | 80% CVG | — | 1.2 | 395 | 592277 |
| 12 | 78% CVG + 2% Ketjen | 39/1 | 24.0 | | — |
| 14 | 78% CVG + 2% Printex | 39/1 | 19.7 | 530 | 794363 |
| * | 80% NFG | — | 1.7 | 403 | 605100 |
| 13 | 78% NFG + 2% Ketjen | 39/1 | 16.5 | 530 | 794363 |
| 19 | 59.5% CVG + 5.5% Ketjen | 10.8/1 | 9.9 | | — |
| 20 | 55% CVG + 9% Ketjen | 6.1/1 | 26.1 | 528 | 792196 |

| | | | |
|---|---|---|---|
| * | 62.5% CVG + 7.5% Ketjen | 8.3/1 | Not Processible |

It may be generally seen that a higher proportion of graphite may be used at higher total filler loadings. The synergistic effect obtained is most pronounced in polyamide systems (most probably due to crystallinity and high heat of crystallization).

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

1. A conductive composition comprising:
an organic polymer;
a nanosized conductive filler and/or carbon fibers having an average diameter of greater than or equal to about 1000 nanometers; and
graphite.

2. The composition of claim 1, wherein the organic polymer is a thermoplastic polymer or a thermosetting polymer.

3. The composition of claim 2, wherein the thermoplastic polymer is a polyacetal, polyacrylic, polycarbonate, polystyrene, polyester, polyamide, polyamideimide, polyarylate, polyarylsulfone, polyethersulfone, polyphenylene sulfide, polyvinyl chloride, polysulfone, polyimide, polyetherimide, polytetrafluoroethylene, polyetherketone, polyether etherketone, polyether ketone ketone, polybenzoxazole, polyoxadiazole, polybenzothiazinophenothiazine, polybenzothiazole, polypyrazinoquinoxaline, polypyromellitimide, polyquinoxaline, polybenzimidazole, polyoxindole, polyoxoisoindoline, polydioxoisoindoline, polytriazine, polypyridazine, polypiperazine, polypyridine, polypiperidine, polytriazole, polypyrazole, polypyrrolidine, polycarborane, polyoxabicyclononane, polydibenzofuran, polyphthalide, polyacetal, polyanhydride, polyvinyl ether, polyvinyl thioether, polyvinyl alcohol, polyvinyl ketone, polyvinyl halide, polyvinyl nitrile, polyvinyl ester, polysulfonate, polysulfide, polythioester, polysulfone, polysulfonamide, polyurea, polyphosphazene, polysilazane, or a combination comprising at least one of the foregoing organic polymers.

4. The composition of claim 2, wherein the thermosetting resins are polyurethane, natural rubber, synthetic rubber, epoxy, phenolic, polyesters, polyamides, silicones, or a combination comprising at least one of the foregoing thermosetting resins.

5. The composition of claim 1, wherein the organic polymer is a blend of a thermoset polymer and a blend of a thermoplastic polymer.

6. The composition of claim 1, wherein the graphite is naturally occurring graphite, wherein the naturally occurring graphite is flake graphite, amorphous graphite or crystal vein graphite having an aspect ratio of greater than or equal to about 2.

7. The composition of claim 1, wherein the graphite generally has average particle sizes of about 1 to about 5,000 micrometers.

8. The composition of claim 1, wherein the conductive composition comprises graphite in an amount of about 40 to about 90 wt %, based on the total weight of the composition.

9. The composition of claim 1, wherein the nanosized conductive fillers have at least one dimension less than or equal to about 1000 nanometers.

10. The composition of claim 1, wherein the nanosized conductive fillers are in the form of powder, drawn wires, strands, fibers, tubes, nanotubes, rods, whiskers, flakes, laminates, platelets, ellipsoids, discs, spheroids, fractals or combinations comprising at least one of the foregoing forms.

11. The composition of claim 1, wherein the nanosized conductive fillers are single wall carbon nanotubes, multiwall carbon nanotubes, vapor grown carbon fibers, carbon black, conductive metal particles, conductive metal oxides, metal coated fillers, or a combination comprising at least one of the foregoing nanosized conductive fillers.

12. The composition of claim 11, wherein the carbon black is used in amounts of about 0.001 to about 80 wt % of the total weight of the conductive composition.

13. The composition of claim 11, wherein the carbon black is used in amounts of about 0.25 to about 5 wt % of the total weight of the conductive composition.

14. The composition of claim 1, wherein the carbon fibers are obtained from pitch or polyacrylonitrile and have an aspect ratio of greater than or equal to about 5.

15. The composition of claim 1, wherein the ratio of the nanosized conductive filler and/or the carbon fibers to the graphite is about 1:6 to about 1:80.

16. The composition of claim 1, wherein the viscosity of the electrically conductive composition is about 100 to about 600 Pascal-seconds at 1500 sec⁻¹.

17. A method for manufacturing a composition comprising:
blending an organic polymer; a nanosized conductive filler and/or carbon fibers having a diameter of greater than or equal to about 1000 nanometers; and
graphite, wherein the composition has an electrical volume resistivity less than or equal to about 10e⁸ ohm-cm.

18. The method of claim 17, wherein the blending comprises melt blending, solution blending or combinations comprising at least one of the foregoing methods of blending.

19. The method of claim 17, wherein the blending involves the use of shear force, extensional force, compressive force, ultrasonic energy, electromagnetic energy, thermal energy or combinations comprising at least one of the foregoing forces and energies and is conducted in processing equipment wherein the aforementioned forces are exerted by a single screw, multiple screws, intermeshing co-rotating or counter rotating screws, non-intermeshing co-rotating or counter rotating screws, reciprocating screws, screws with pins, barrels with pins, screen packs, rolls, rams, helical rotors, or combinations comprising at least one of the foregoing.

20. The method of claim 17, wherein the blending comprises extrusion.

21. The method of claim 17, wherein the blending comprises melt blending or solution blending, and wherein the blending utilizes a fluid in the liquid state, the gaseous state, the supercritical state or combinations comprising at least one of the foregoing states.

22. The method of claim 17, wherein specific energy utilized for the blending is an amount of about 0.01 kwhr/kg to about 10 kwhr/kg.

23. The method of claim 17, further comprising injection molding the composition.

24. An article manufactured from the composition of claim 1.

25. An article manufactured by the method of claim 17.
